(19) United States
(12) Patent Application Publication
(10) Pub. No.: US 2010/0284112 A1
(43) Pub. Date: Nov. 11, 2010

(54) HEAD SUSPENSION UNIT, HEAD SUSPENSION ASSEMBLY, AND STORAGE DEVICE

(75) Inventor: Takeshi OHWE, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/841,899

(22) Filed: Jul. 22, 2010

Related U.S. Application Data
(63) Continuation of application No. PCT/JP2008/066106, filed on Sep. 5, 2008.

(51) Int. Cl. G11B 5/48

(52) U.S. Cl. 360/246.1; G9B/5.147

(57) ABSTRACT

According to one embodiment, a head suspension unit includes: a head suspension; a thin plate body of a flexure attached to a surface of the head suspension and holding an insulating layer on the surface thereof; a wiring pattern formed on a surface of the insulating layer and forming a hollow conductor defining a hollow space extending along the surface of the insulating layer; and an insulating material filling the hollow space.

### CROSS-REFERENCE TO RELATED APPLICATIONS

This application is a continuation of PCT international application Ser. No. PCT/JP2008/066106 filed on Sep. 5, 2008 which designates the United States, incorporated herein by reference.

### FIELD

Embodiments described herein relate generally to a head suspension unit, a head suspension assembly, and a storage device.

### BACKGROUND

For example, in a hard disk drive (HDD), ahead suspension is mounted to the end of a carriage arm. On a surface of the head suspension, a flexure is attached. On the flexure, a head slider is fixed. The flexure comprises a wiring pattern. Based on the wiring pattern, a sense current and a write current are exchanged between an electromagnetic conversion element incorporated in the head slider and a head IC on a carriage block.

In a wiring pattern, based on the so-called skin effect, a current densely flows along the surface. For example, in a copper wiring pattern, a skin depth of about 2 μm from the surface of the wiring pattern is defined for a frequency of 1 GHz. In a conventional wiring pattern, a thickness more than the skin depth for Copper is defined. Therefore, with such a wiring pattern, a current cannot effectively flow.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view schematically illustrating an internal structure of a hard disk drive (HDD) according to an embodiment;

FIG. 2 is an exemplary perspective view of a head suspension assembly in the embodiment;

FIG. 3 is an exemplary cross sectional view, taken along the line 3-3 of FIG. 2, of the head suspension assembly according to a first embodiment;

FIG. 4 is an exemplary graph representing a relationship between a thickness and a height of a wiring pattern in the first embodiment;

FIG. 5 is an exemplary schematic diagram illustrating process of forming a first resist mask on the surface of an insulating layer in the first embodiment;

FIG. 6 is an exemplary schematic diagram of process of forming a first conductive layer on the surface of the insulating layer based on the first resist mask in the first embodiment;

FIG. 7 is an exemplary schematic diagram of process of forming a second resist mask on the first resist mask and the first conductive layer in the first embodiment;

FIG. 8 is an exemplary schematic diagram of process of forming a second conductive layer on the first conductive layer based on the second resist mask in the first embodiment;

FIG. 9 is an exemplary schematic diagram of process of forming a third conductive layer on the second conductive layer based on the third resist mask in the first embodiment;

FIG. 10 is an exemplary schematic diagram of process of removing a resist mask on the insulating layer in the first embodiment;

FIG. 11 is an exemplary cross sectional view of a head suspension assembly according to a second embodiment;

FIG. 12 is an exemplary schematic diagram of process of forming a first resist mask on the surface of an insulating layer in the second embodiment;

FIG. 13 is an exemplary schematic diagram of process of forming a first conductive layer on the surface of the insulating layer based on the first resist mask in the second embodiment;

FIG. 14 is an exemplary schematic diagram of process of forming a second resist mask on the first resist mask and the first conductive layer in the second embodiment;

FIG. 15 is an exemplary schematic diagram of process of forming a second conductive layer on the first conductive layer based on the second resist mask in the second embodiment;

FIG. 16 is an exemplary schematic diagram of process of forming a third resist mask on the second resist mask in the second embodiment;

FIG. 17 is an exemplary schematic diagram of process of forming a third conductive layer on the second conductive layer based on the third resist mask in the second embodiment;

FIG. 18 is an exemplary schematic diagram of process of forming a fourth resist mask on the third resist mask in the second embodiment;

FIG. 19 is an exemplary schematic diagram of process of forming a fourth conductive layer on the third conductive layer based on the fourth resist mask in the second embodiment;

FIG. 20 is an exemplary schematic diagram of process of forming a fifth resist mask on the fourth resist mask in the second embodiment;

FIG. 21 is an exemplary schematic diagram of process of forming a fifth conductive layer on the fourth conductive layer based on the fifth resist mask in the second embodiment;

FIG. 22 is an exemplary schematic diagram of process of removing a resist mask on the insulating layer in the second embodiment; and

FIG. 23 is an exemplary cross sectional view of alternative of the head suspension assembly in the second embodiment.

### DETAILED DESCRIPTION

In general, according to one embodiment, a head suspension unit comprises: a head suspension; a thin plate body of a flexure attached to a surface of the head suspension and holding an insulating layer on the surface thereof; a wiring pattern formed on a surface of the insulating layer and forming a hollow conductor defining a hollow space extending along the surface of the insulating layer; and an insulating material filling the hollow space.

According to another embodiment, a head suspension assembly comprises: a head suspension; a thin plate body of a flexure attached to a surface of the head suspension and holding an insulating layer on the surface thereof; a head slider supported on a surface of the thin plate body; a wiring pattern formed on a surface of the insulating layer, connected to the head slider, and forming a hollow conductor defining a hollow space extending along the surface of the insulating layer; and an insulating material filling the hollow space.

According to still another embodiment, a storage device comprises: a housing; a storage medium incorporated in the housing; a head slider facing the storage medium; a head suspension supporting the head slider; a thin plate body of a flexure attached to a surface of the head suspension, holding an insulating layer on the surface thereof, and supporting the head slider on the surface thereof; a wiring pattern formed on a surface of the insulating layer, connected to the head slider, and forming a hollow conductor defining a hollow space extending along the surface of the insulating layer; and an insulating material filling the hollow space.

Various embodiments will be described hereinafter with reference to the accompanying drawings.

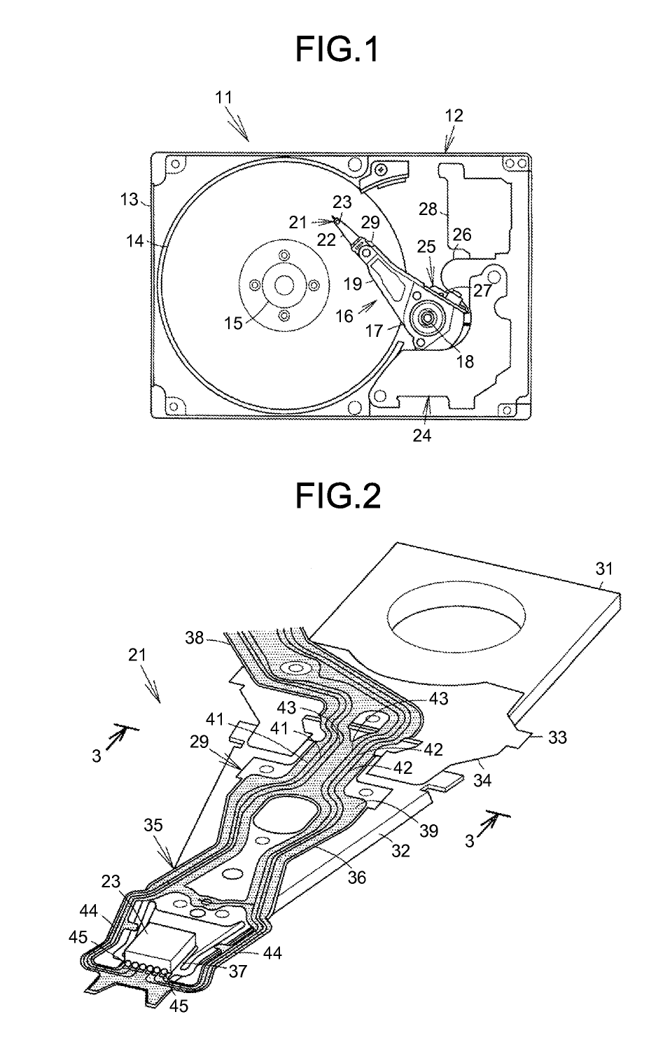

FIG. 1 schematically illustrates an internal structure of a hard disk drive (HDD) 11 as an example of a storage device according to an embodiment. The HDD 11 comprises a housing 12. The housing 12 has a box-shaped base 13 and a cover (not illustrated). The base 13 defines, for example, a flat, rectangular parallelepiped internal space, or storage space. The base 13 may be formed by casting of a metal material such as Aluminum (Al). The cover is connected to an opening of the base 13. The storage space between the cover and the base 13 is closed hermetically. For example, the cover may be made of one plate material by press working.

In the storage space, at least one magnetic disk 14 is stored as a storage medium. The magnetic disk 14 is mounted on a drive shaft of a spindle motor 15. The spindle motor 15 can rotate the magnetic disk 14 at high speed, such as 3,600 round per minutes (rpm), 4,200 rpm, 5,400 rpm, 7,200 rpm, 10,000 rpm, or 15,000 rpm. For example, the magnetic disk 14 is configured as a vertical magnetic recording disk. In other words, the easy magnetization axis on a recording magnetic film on the magnetic disk 14 is set in the vertical direction perpendicular to the surface of the magnetic disk 14.

In the storage space, a carriage 16 is also provided. The carriage 16 comprises a carriage block 17, which is rotatably connected to a support shaft 18 extending in the vertical direction. In the carriage block 17, a plurality of carriage arms 19 is defined extending horizontally from the support shaft 18. For example, the carriage block 17 may be made of Aluminum (Al) by extrusion.

To the end of each of the carriage arms 19, a head suspension assembly 21 is attached. The head suspension assembly 21 comprises ahead suspension 22 attached to the end of the carriage arm 19. The head suspension 22 extends frontward from the end of the carriage arm 19. The head suspension 22 has a flexure attached thereto. At the end of the head suspension 22, a gimbal is defined in the flexure. On the gimbal, a magnetic head slider, or equivalently, a flying head slider 23 is mounted. With the operation of the gimbal, the flying head slider 23 can change the attitude relative to the head suspension 22. On the flying head slider 23, an electromagnetic conversion element is mounted as a magnetic head.

When air flow is generated on the surface of the magnetic disk 14 by rotation of the magnetic disk 14, the air flow acts so that the positive pressure, or equivalently, buoyant force and the negative pressure act on the flying head slider 23. When the buoyant force equals the negative pressure and a pressing force of the head suspension 22, the flying head slider 23 can be kept flying with relatively high rigidity during rotation of the magnetic disk 14.

To the carriage block 17, for example, a power source such as a voice coil motor (VCM) 24 is connected. The action of the VCM 24 can rotates the carriage block 17 around the support shaft 18. Such rotation of the carriage block 17 is a basis to realize swinging of the carriage arm 19 and the head suspension 22. When the carriage arm 19 swings around the support shaft 18 while the flying head slider 23 is flying, the flying head slider 23 can move along the radial line of the magnetic disk 14. Consequently, the electromagnetic conversion element on the flying head slider 23 can come across the data zone between innermost recording track and the outermost recording track. Then, the electromagnetic conversion element on the flying head slider 23 can be positioned on a target recording track.

As can be seen from FIG. 1, on the carriage block 17, a flexible printed board unit 25 is arranged. The flexible printed board unit 25 comprises a head integrated circuit (IC) 27 mounted on a flexible printed board 26. Upon reading magnetic information, from the head IC 27 to a reading element of the electromagnetic conversion element, a sense current is supplied. Similarly, upon writing of magnetic information, from the head IC 27 to a writing element of the electromagnetic conversion element, a write current is supplied. To the head IC 27, a sense current and a write current are supplied from a small circuit board 28 arranged in the storage space and a printed circuit board (not illustrated) attached to the rear of the bottom plate of the base 13. Upon supplying such a sense current and a write current, a flexure 29 is used. The flexure 29 has one end connected to the flexible printed board unit 25. The flexure 29 extends along a side edge of the carriage arms 19 and has the other end attached to the head suspension 22. The head suspension 22 and the flexure 29 constitute the head suspension of the embodiment.

FIG. 2 schematically illustrates a structure of the head suspension assembly 21 according to the embodiment. The head suspension assembly 21 comprises a base plate 31 attached to the end of the carriage arm 19 and a load beam 32 arranged in front of the base plate 31 with a predetermined space apart. The base plate 31 is fixed on the carriage arm 19 by caulking, for example. On the surfaces of the base plate 31 and the load beam 32, a hinge plate 33 is fixed. The hinge plate 33 defines an elastic deformation portion 34 between the front end of the base plate 31 and the back end of the load beam 32. Accordingly, the hinge plate 33 connects the base plate 31 and the load beam 32. The base plate 31, the load beam 32, and the hinge plate 33 constitute the head suspension 22.

On the surface of the head suspension 22, the flexure 29 is fixed. The flexure 29 may be fixed by spot welding at a plurality of welded-spots, for example. For the spot welding, for example, a neodymium-doped yttrium aluminum garnet (YAG) laser may be used. The flexure 29 comprises a thin plate body 35. The thin plate body 35 is formed by one plate spring. The plate spring may be made of, for example, a uniform stainless steel plate. The thin plate body 35 defines a fixed plate 36 fixed on the head suspension 22, a gimbal 37 connected to the fixed plate 36, and an outer plate 38 connected to the fixed plate 36 and arranged outer than the contour of the head suspension 22. The gimbal 37 can change the attitude relative to the fixed plate 36. On the surface of the gimbal 37, the flying head slider 23 is fixed. The flying head slider 23 may be fixed by using an adhesive, for example. The outer plate 38 extends along a side surface of the carriage arm 19 to the flexible printed board unit 25. Accordingly, the head suspension assembly 21 is formed in so-called long tail.

On the back side of the flying head slider 23, the gimbal 37 is received by a domal projection (not illustrated) formed on the surface of the load beam 32. The elastic deformation portion 34 described above exercises a predetermined elasticity, namely a bending force. The bending force acts so as to apply a pressing force, which is toward the surface of the magnetic disk 14, to the front end of the load beam 32. The pressing force acts on the flying head slider 23 from the back side of the gimbal 37 with the action of the projection. The flying head slider 23 can change the attitude by the buoyant force generated by the air flow. The projection allows an attitude change of the flying head slider 23 and then allows that of the gimbal 37.

On the flexure 29, an insulating layer 39 is formed on the surface of the thin plate body 35. For the insulating layer 39, a resin material such as polyimide resin may be used. On the surface of the insulating layer 39, for example, three pairs of wiring patterns 41, 42, and 43 are formed. The wiring patterns 41 to 43 extend in parallel to each other on the surface of the insulating layer 39. Between the wiring patterns 41, 41 and the wiring patterns 42, 42, the wiring patterns 43, 43 are arranged. The wiring patterns 41 to 43 defines, on the insulating layer 39, one pair of outer regions 44 arranged outer than the contour of the thin plate body 35. Between the outer regions 44, 44, the flying head slider 23 is positioned. In the outer regions 44, the wiring patterns 41 to 43 are received only by the insulating layer 39 and are not received by the thin plate body 35.

The wiring patterns 41 to 43 are individually connected to the flying head slider 23 by conductors 45. The wiring pattern 41 is connected to the writing element of the electromagnetic conversion element. Accordingly, to the writing element, a write current is supplied. Corresponding to the supply of the write current, a magnetic field is generated, for example, by the thin film coil pattern. The wiring pattern 42 is connected to the reading element of the electromagnetic conversion element. Accordingly, to the reading element, a sense current is supplied. At the same time, a voltage change by the sense current is retrieved. On the other hand, the wiring pattern 43 is connected to a heater adjacent to the electromagnetic conversion element. The heater generates heat when supplied with a current. A projection is formed on the flying head slider 23 in accordance with the generated heat. The floating height of the electromagnetic conversion element is adjusted in accordance with the projection.

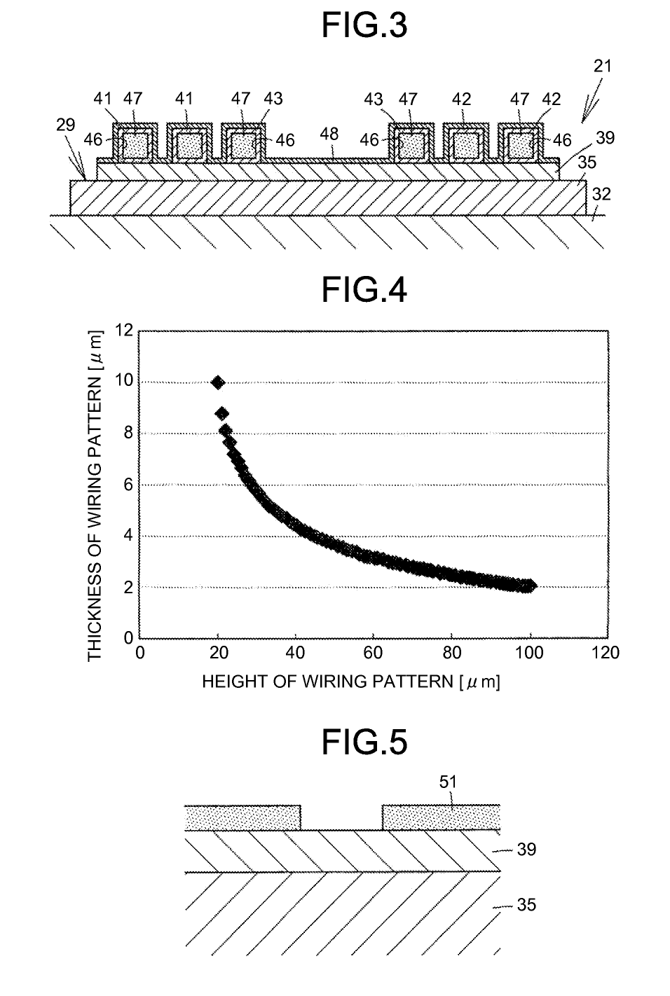

FIG. 3 schematically illustrates a cross sectional structure of the head suspension assembly 21 according to a first embodiment. Each of the wiring patterns 41 to 43 is formed by a hollow conductor defining hollow spaces 46 extending along the surface of the insulating layer 39. The wiring patterns 41 to 43 may be made of a conductive material such as copper (Cu). In the first embodiment, a contour of a cross section of each of the wiring patterns 41 to 43, which crosses each of the wiring patterns 41 to 43 perpendicularly thereto, are defined in a rectangle. Similarly, contours of the cross sections of the hollow spaces 46, which cross the wiring patterns 41 to 43 perpendicularly thereto, are formed in a rectangle. The hollow spaces 46 are filled with insulating materials 47. Over the peripheries of the insulating materials 47, the wiring patterns 41 to 43 are defined to have a uniform thickness. On the surface of the insulating layer 39, the wiring patterns 41 to 43 are covered by a protective layer 48. The insulating materials 47 and the protective layer 48 may be made of a resin material such as polyimide resin. The contour of the cross section of each of the wiring patterns 41 to 43 may be defined in a rectangle including a square.

FIG. 4 represents a relationship between the height [m] of the wiring patterns 41 to 43 from the surface of the insulating layer 39 and the thickness [m] of the wiring patterns 41 to 43 where the width of the wiring patterns 41 to 43 is set to 25 μm, for example. Here, the cross sectional area of only the wiring patterns 41 to 43 is set to 500 μm². Generally, when a frequency of a signal to be transmitted is set to 1 GHz, the so-called skin depth of Cu is defined to about 2 μm. Specifically, in a case where Cu is used, a current densely flows in a region of 2 μm depth from the surface. Therefore, it is desirable to set the thickness of the wiring patterns 41 to 43 at least larger than the skin depth of Cu.

To obtain the cross sectional area 500 μm² of the wiring patterns 41 to 43, when the width is set to 25 μm, for example and the height is set to 50 μm, for example, the thickness of the wiring patterns 41 to 43 is set to about 3.7 μm as represented in FIG. 4. At this time, the outer peripheries of the wiring patterns 41 to 43 defined by the contours of the cross sections thereof have a length of 150 μm. On the other hand, the section of a conventional wiring pattern is defined in a rectangle. In a conventional wiring pattern, to obtain the cross sectional area of 500 μm², the width may be set to 25 μm, for example and the height may be set to 20 μm, for example. At this time, the outer periphery of the wiring pattern defined by the contour of the cross section thereof has a length of 90 μm. Therefore, each of the wiring patterns 41 to 43 can secure the outer periphery to have 1.7 times the length of the conventional wiring pattern. The surface area of the wiring patterns 41 to 43 can be significantly increased with respect to the conventional surface area.

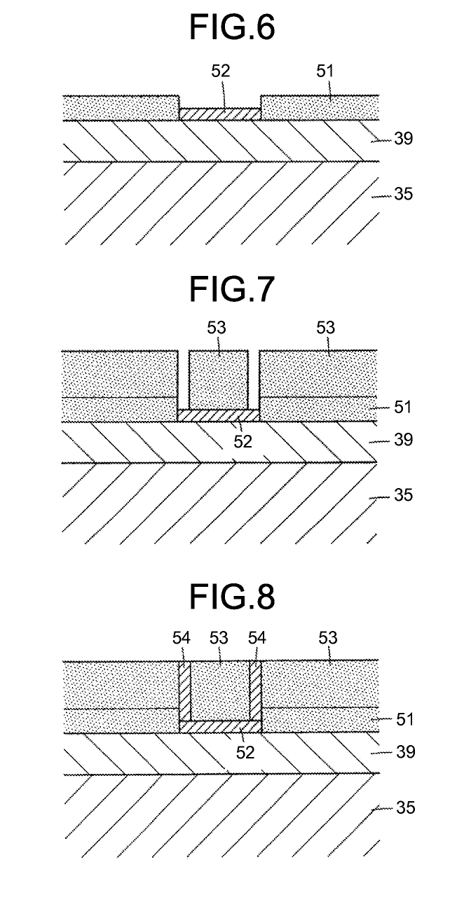

On the other hand, to secure the skin depth of 2 μm, as represented in FIG. 6, it is desired that the height of the wiring patterns 41 to 43 is set to, for example, 100 μm or less. For example, when the height is set to 100 μm, the outer periphery defined along each of the contours of the cross sections of the wiring patterns 41 to 43 is set to 250 μm. On the other hand, the outer periphery of the conventional wiring pattern is defined to have a length of 90 μm. Therefore, each of the wiring patterns 41 to 43 can secure the outer periphery to have 2.8 times the length of the conventional wiring pattern. The surface area of the wiring patterns 41 to 43 can be significantly increased with respect to the conventional surface area. In this case, the wiring patterns 41 to 43 can maximize a transmission efficiency.

With the head suspension assembly 21 described above, based on the skin effect, a current densely flows along the surface, which is an outer peripheral surface, of each of the wiring patterns 41 to 43. Each of the wiring patterns 41 to 43 is formed by a hollow conductor. Therefore, even when almost the same amount of conductor as the conventional wiring pattern is used for the wiring patterns 41 to 43, the wiring patterns 41 to 43 can secure a larger surface area than the conventional wiring pattern. Consequently, with the wiring patterns 41 to 43, a current flows more effectively comparing to the conventional wiring pattern. The transmission speed of a signal, that is a current, can be further improved than the conventional wiring pattern.

In addition, since each of the wiring patterns 41 to 43 is formed by a hollow conductor, a ratio of the outer peripheral surface facing the thin plate body 35 is decreased. Consequently, an effect of the proximity effect generated between the thin plate body 35 and the wiring patterns 41 to 43 can be minimized. Ununiformity of the current density in the wiring patterns 41 to 43 can be prevented as much as possible. On the other hand, since the conventional wiring pattern cannot secure a sufficient surface area, a ratio of the outer peripheral surface facing a thin plate body is increased. Consequently, due to the proximity effect, a current density increases along the outer peripheral surface facing the thin plate body. Unfortunately, the current density becomes non-uniform.

Since each of the wiring patterns 41 to 43 defines the hollow space 46, increase of a mass of the wiring patterns 41 to 43 can be prevented as much as possible. Through an analysis to be described below, a resonance frequency of the head suspension 22 can be suppressed to low. The positioning accuracy of the flying head slider 23 can be prevented from being deteriorated. On the other hand, to secure a the surface area same as the wiring patterns 41 to 43, the conventional rectangular wiring pattern has the same contour as the wiring patterns 41 to 43 and a space corresponding to the hollow space 46 is filled with a conductive material. In this case, a mass of the wiring pattern is significantly increased, it cannot be expected that the resonance frequency of the head suspension 22 is suppressed, and the positioning accuracy of the flying head slider 23 cannot be prevented from being deteriorated.

The effects of the first embodiment has been verified based on the analysis. For the verification, a concrete example and a comparative example were obtained. As the concrete example, the head suspension assembly 21 described above was used. For the comparative example, the conventional wiring pattern was used instead of the wiring patterns 41 to 43. The width of the wiring patterns 41 to 43 was set to 25 μm. The height of the wiring patterns 41 to 43 was set to 100 μm. For the conventional wiring pattern, the space corresponding to the hollow spaces 46 of the wiring patterns 41 to 43 were filled with Cu. The conventional wiring pattern has 5 times the mass of the wiring patterns 41 to 43 per unit length. At this time, resonance frequencies were calculated for the concrete example and the comparative example.

Consequently, the head suspension assembly 21 according to the concrete example suppressed the resonance frequency by about 5% in a first bending mode and a first torsional mode with respect to the head suspension assembly according to the comparative example. In the concrete example, particularly in the outer region 44 of the wiring patterns 41 to 43, the resonance frequency in the first bending mode and the first torsional mode was suppressed by about 50% with respect to the comparative example. Therefore, in the head suspension assembly 21 according to the first embodiment, the wiring patterns 41 to 43 can have a smaller width and a larger surface area than the head suspension assembly using the conventional wiring pattern. Consequently, the head suspension assembly 21 can realize high speed transmission of the signal.

Next, a method of manufacturing the flexure 29 is explained. First, the thin plate body 35 made of a stainless steel plate is prepared. As illustrated in FIG. 5, on the surface of the thin plate body 35, the insulating layer 39 made of a polyimide resin is formed. On the surface of the insulating layer 39, a first resist mask 51 is formed to have a predetermined pattern. As illustrated in FIG. 6, on the exterior of the first resist mask 51 and on the surface of the insulating layer 39, a first conductive layer 52 made of Cu is formed. The first conductive layer 52 may be formed by, for example, deposition, sputtering, or plating. The film thickness of the first conductive layer 52 is set to the film thickness of the wiring patterns 41 to 43.

As illustrated in FIG. 7, on the surface of the insulating layer 39, a second resist mask 53 is formed on the first resist mask 51 and the first conductive layer 52 so as to have a predetermined pattern. On the exterior of the second resist mask 53, the first conductive layer 52 is exposed. Thereafter, as illustrated in FIG. 8, on the exterior of the second resist mask 53 and on the first conductive layer 52, a second conductive layer 54 made of Cu is formed. The second conductive layer 54 may be formed by, for example, deposition, sputtering, or plating. The width of the second conductive layer 54 is set to the film thickness of the wiring patterns 41 to 43. The first resist mask 51 and the second resist mask 53 may be made of a resin such as polyimide resin.

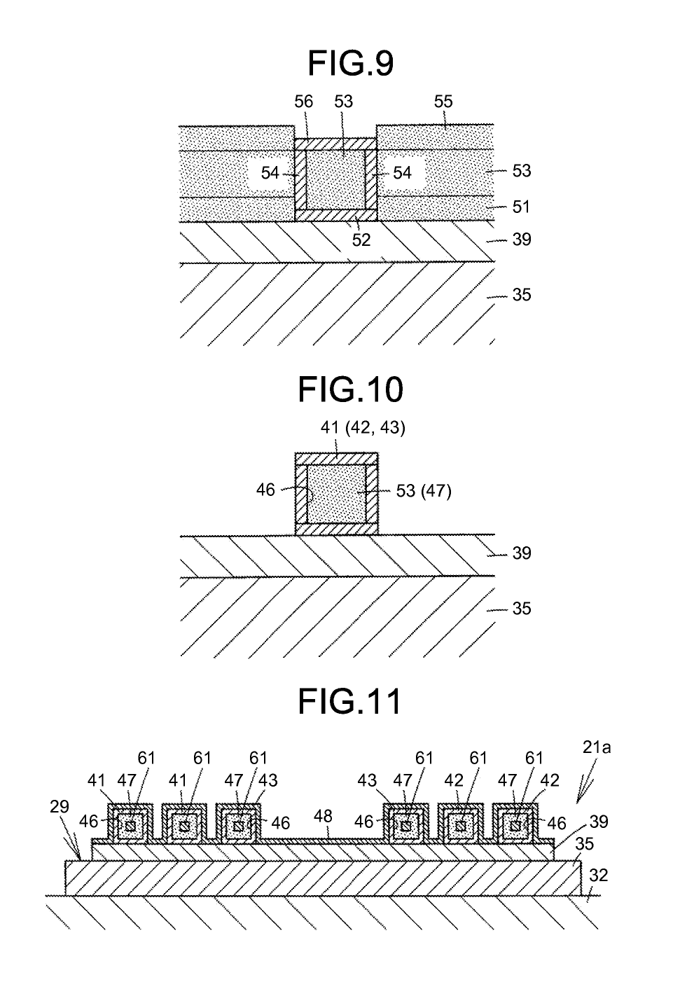

Thereafter, as illustrated in FIG. 9, on the surface of the insulating layer 39, a third resist mask 55 is formed on the second resist mask 53 so as to have a predetermined pattern. On the exterior of the third resist mask 55, the second conductive layer 54 is exposed. Then, on the exterior of the third resist mask 55 and on the second conductive layer 54, a third conductive layer 56 made of Cu is formed. The third conductive layer 56 may be formed by, for example, deposition, sputtering, or plating. The film thickness of the third conductive layer 56 is set to the film thickness of the wiring patterns 41 to 43. Accordingly, based on the first to third conductive layers 52, 54, and 56, the wiring patterns 41 to 43 are formed. The third resist mask 55 may be made of a resin such as polyimide resin.

As illustrated in FIG. 10, on the exterior of the wiring patterns 41 to 43, the first to third resist masks 51, 53, and 55 are removed. On the interior of the wiring patterns 41 to 43, the second resist mask 53 remains. The remaining second resist mask 53 serves as the insulating material 47. Thereafter, on the surface of the insulating layer 39, the protective layer 48 covering the wiring patterns 41 to 43 is formed. Accordingly, the flexure 29 is formed. When the head suspension assembly 21 is assembled, the flexure 29 is attached to the surface of the head suspension 22. On the gimbal 37 of the flexure 29, the flying head slider 23 is attached.

FIG. 11 schematically illustrates a cross sectional structure of a head suspension assembly 21a according to a second embodiment. In the hollow space 46 in each of the wiring patterns 41 to 43, an inner wiring pattern 61 made of a conductor is embedded inside the insulating material 47. For example, the wiring patterns 41 to 43 serve as signal lines and the inner wiring patterns 61 serve as ground lines. On the contrary, for example, the wiring patterns 41 to 43 may serve as ground lines and the inner wiring pattern 61 may serve as signal lines. The inner wiring patterns 61 extend along the surface of the insulating layer 39. The contours of the cross sections of the inner wiring patterns 61, which cross the inner wiring patterns 61 perpendicularly thereto, are defined in a rectangle. The contour of the cross section of each of the inner wiring patterns 61 is defined to have a similar shape to the contour of the cross section of each of the inner wiring patterns 41 to 43. The distance between the outer peripheral surface of each of the inner wiring patterns 61 and the inner peripheral surface of each of the wiring patterns 41 to 43 is defined uniformly over the periphery of the inner wiring pattern 61. Specifically, the thickness of the insulating material 47 is set uniformly over the periphery of the inner wiring pattern 61. The inner wiring pattern 61 may be made of a conductive material such as Cu. Through the inner wiring pattern 61, the so-called return current flows. Other parts and structures of the head suspension assembly are equivalent to those of the head suspension assembly 21 and denoted by like reference numerals.

With the head suspension assembly 21a described above, operational effects similarly to those described above can be attained. In addition, the distance between the outer peripheral surface of each of the inner wiring patterns 61 and the inner peripheral surface of each of the wiring patterns 41 to 43 is defined uniformly over the periphery of the inner wiring pattern 61. Consequently, even when the proximity effect is generated between the inner wiring pattern 61 and each of the wiring patterns 41 to 43, distribution of the current density can be prevented from varying in the wiring patterns 41 to 43 over the periphery of the inner wiring pattern 61. With the wiring patterns 41 to 43, a current flows with a uniform density over the periphery of the inner wiring pattern 61. With the wiring patterns 41 to 43, a current effectively flows. The transmission speed of a signal is further improved than the conventional wiring pattern. Alternatively, the signal may be transmitted through the inner wiring pattern 61. At this time, through the inner wiring patterns 41 to 43, the return current flows.

It is assumed that the width and the height of the wiring patterns 41 to 43 are set to 25 μm, for example. Since the frequency of the signal is set to 1 GHz, the thickness of the wiring patterns 41 to 43 is set to 2 μm. In this case, in the contour of the cross section, each of the wiring patterns 41 to 43 can secure a length of 84 μm for its inner peripheral surface facing the inner wiring pattern 61. On the other hand, when the width and the height of the conventional wiring pattern are set to 25 μm, for example, the thin plate body 35 of the flexure 29 arranged across the insulating layer 39 serves as a flow path of the return current. In this case, the length of the contour of the cross section of the conventional wiring pattern facing the thin plate body 35 is set to 25 μm. The current density varies in the wiring pattern. Consequently, resistance loss of the current is increased. On the other hand, the wiring patterns 41 to 43 of the second embodiment are defined to have 3.4 times the length of the conventional wiring pattern, so that the variation of distribution of the current density as well as the resistance loss of the current can be securely prevented.

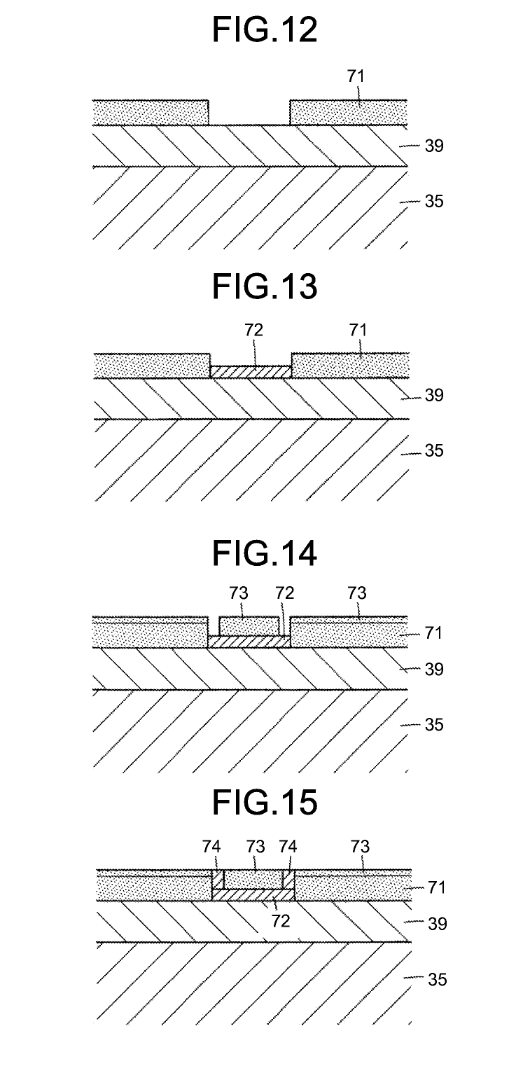

Next, a method of manufacturing the wiring patterns 41 to 43 is explained. First, the thin plate body 35 made of a stainless steel plate is prepared. As illustrated in FIG. 12, on the surface of the thin plate body 35, the insulating layer 39 made of a polyimide resin is formed. On the surface of the insulating layer 39, a first resist mask 71 is formed to have a predetermined pattern. As illustrated in FIG. 13, on the exterior of the first resist mask 71 and on the surface of the insulating layer 39, a first conductive layer 72 made of Cu is formed. The first conductive layer 72 may be formed by, for example, deposition, sputtering, or plating. The film thickness of the first conductive layer 72 is set to the film thickness of the wiring patterns 41 to 43.

As illustrated in FIG. 14, on the surface of the insulating layer 39, a second resist mask 73 is formed on the first resist mask 71 and the first conductive layer 72 so as to have a predetermined pattern. On the exterior of the second resist mask 73, the first conductive layer 72 is exposed. Thereafter, as illustrated in FIG. 15, on the exterior of the second resist mask 73 and on the first conductive layer 72, a second conductive layer 74 made of Cu is formed. The second conductive layer 74 may be formed by, for example, deposition, sputtering, or plating. The width of the second conductive layer 74 is set to the film thickness of the wiring patterns 41 to 43.

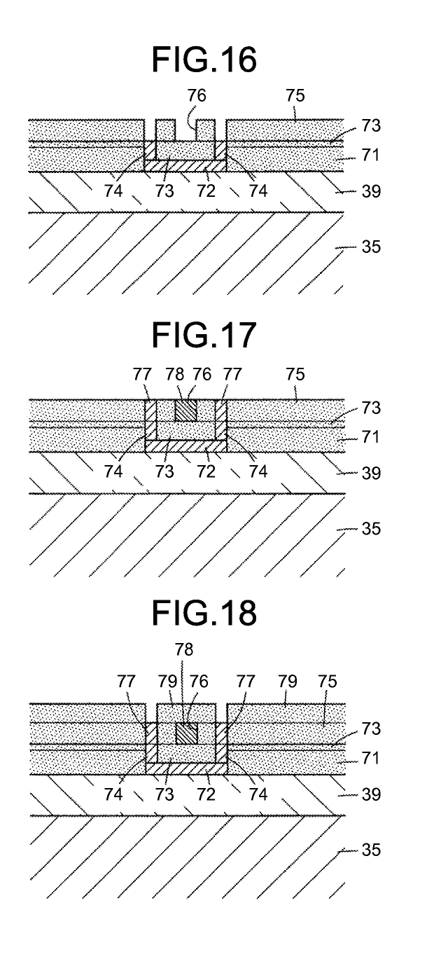

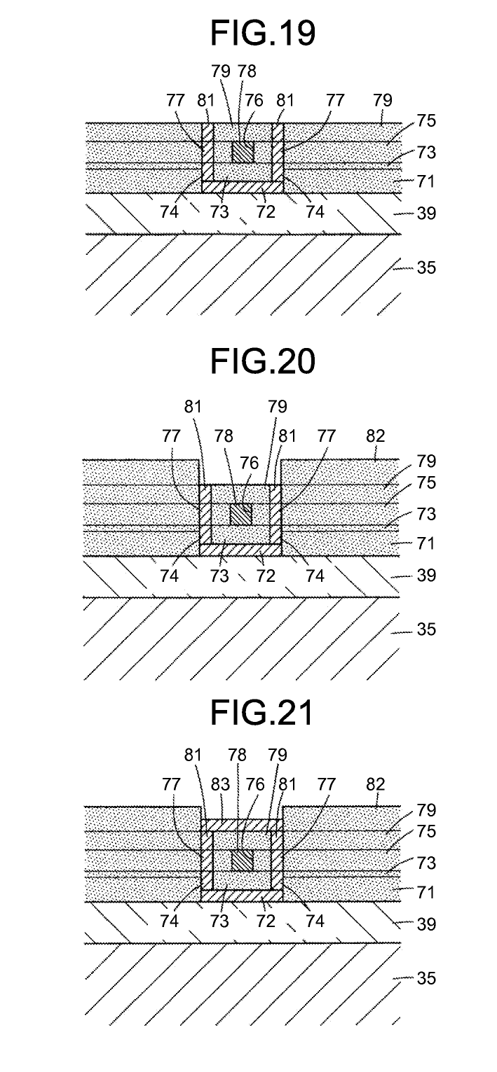

Thereafter, as illustrated in FIG. 16, on the surface of the insulating layer 39, a third resist mask 75 is formed on the second resist mask 73 so as to have a predetermined pattern. On the exterior of the third resist mask 75, the second conductive layer 74 is exposed. On the first conductive layer 72, a groove 76 is formed in the third resist mask 75. The groove 76 extends along the first conductive layer 72. Thereafter, as illustrated in FIG. 17, on the exterior of the third resist mask 75 and on the second conductive layer 74, a third conductive layer 77 made of Cu is formed. At the same time, inside the groove 76, a fourth conductive layer 78 is formed. The fourth conductive layer 78 may be formed by, for example, deposition, sputtering, or plating. The width of the third conductive layer 77 is set to the film thickness of the wiring patterns 41 to 43.

As illustrated in FIG. 18, on the third resist mask 75, a fourth resist mask 79 is formed to have a predetermined pattern. On the exterior of the fourth resist mask 79, the third conductive layer 77 is exposed. On the exterior of the third resist mask 55 and on the surface of the insulating layer 39, a fifth conductive layer 81 made of Cu is formed. The fifth conductive layer 81 may be formed by, for example, deposition, sputtering, or plating. The width of the fifth conductive layer 81 is set to the film thickness of the wiring patterns 41 to 43. Thereafter, as illustrated in FIG. 20, on the fourth resist mask 79, a fifth resist mask 82 is formed to have a predetermined pattern. On the exterior of the fifth resist mask 82, the fifth conductive layer 81 is exposed. The first to fifth resist masks 71, 73, 75, 79, and 82 may be made of a resin such as polyimide resin.

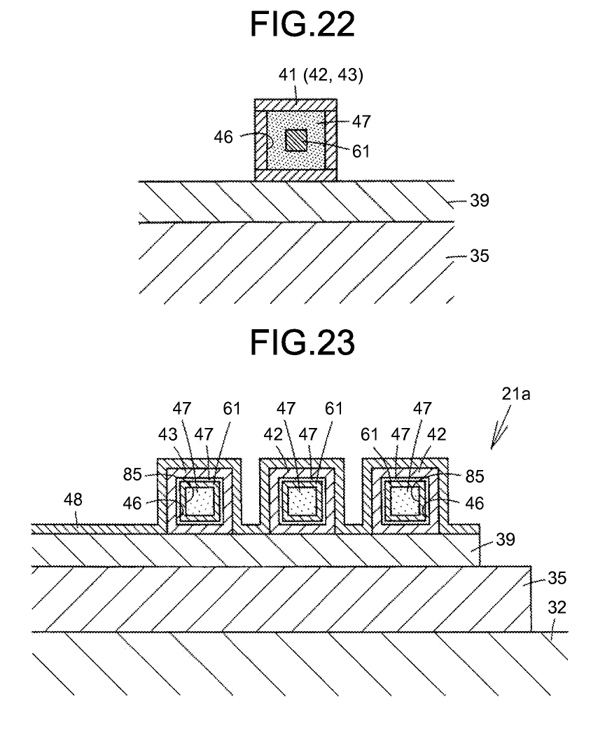

As illustrated in FIG. 21, on the exterior of the fifth resist mask 82 and on the fifth conductive layer 81, a sixth conductive layer 83 is formed. The film thickness of the sixth conductive layer 83 is set to the film thickness of the wiring patterns 41 to 43. Accordingly, based on the first to third, fifth and sixth conductive layers 72, 74, 77, 81 and 83, the wiring patterns 41 to 43 are formed. At the same time, based on the fourth conductive layer 78, the inner wiring pattern 61 is formed. As illustrated in FIG. 22, on the exterior of the wiring patterns 41 to 43, the first to fifth resist masks 71, 73, 75, 79, and 82 are removed. Thereafter, on the surface of the insulating layer 39, the protective layer 48 covering the wiring patterns 41 to 43 is formed. Accordingly, the flexure 29 is formed.

As illustrated in FIG. 23, in the head suspension assembly 21a, hollow spaces 85 may be formed inside the inner wiring patterns 61. The hollow spaces 85 are filled with the insulating materials 47. The distance between the outer peripheral surface of each of the inner wiring patterns 61 and the inner peripheral surface of each of the wiring patterns 41 to 43 is defined uniformly over the periphery of the inner wiring pattern 61. Specifically, the thickness of the insulating material 47 is set uniformly over the periphery of the inner wiring pattern 61. Other parts and structures of the head suspension assembly 21 are equivalent to those of the head suspension assembly 21 and denoted by like reference numerals. With the head suspension assembly 21a described above, operational effects similarly to those described above can be attained. The flexure 29 may be manufactured by a method of manufacturing similar to that described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head suspension unit comprising:
a head suspension;
a thin plate body of a flexure attached to a surface of the head suspension comprising an insulating layer on the surface thereof;
a wiring pattern on a surface of the insulating layer which is a hollow conductor defining a hollow space along the surface of the insulating layer; and
an insulating material in the hollow space.

2. The head suspension unit of claim 1, wherein a thickness of the wiring pattern is substantially uniform over a periphery of the insulating material.

3. The head suspension unit of claim 1, further comprising: an inner wiring pattern along the surface of the thin plate body which is a conductor embedded inside the insulating material.

4. The head suspension unit of claim 3, wherein a thickness of the insulating material is substantially uniform over a periphery of the inner wiring pattern.

5. The head suspension unit of claim 3, wherein a contour of a cross section of the inner wiring pattern and a contour of a cross section of the wiring pattern are similar to each other in shape.

6. The head suspension unit of claim 3, wherein a contour of a cross section of the insulating material is rectangular.

7. The head suspension unit of claim 6, wherein a contour of a cross section of the inner wiring pattern is rectangular.

8. A head suspension assembly comprising:
a head suspension;
a thin plate body of a flexure attached to a surface of the head suspension comprising an insulating layer on the surface thereof;
a head slider on a surface of the thin plate body;
a wiring pattern on a surface of the insulating layer, connected to the head slider, the wiring pattern being a hollow conductor defining a hollow space along the surface of the insulating layer; and
an insulating material in the hollow space.

9. A storage device comprising:
a housing;
a storage medium in the housing;
a head slider facing the storage medium;
a head suspension configured to support the head slider;
a thin plate body of a flexure attached to a surface of the head suspension, comprising an insulating layer on the surface thereof, and supporting the head slider on the surface thereof;
a wiring pattern on a surface of the insulating layer, connected to the head slider, the wiring pattern being a hollow conductor defining a hollow space along the surface of the insulating layer; and
an insulating material in the hollow space.
